(19) United States
(12) Patent Application Publication
(10) Pub. No.: US 2025/0118302 A1
(43) Pub. Date: Apr. 10, 2025

(54) ELECTRONIC DEVICE AND METHOD FOR REINFORCEMENT LEARNING

(71) Applicant: ELECTRONICS AND TELECOMMUNICATIONS RESEARCH INSTITUTE, Daejeon (KR)

(72) Inventor: Yo Han LEE, Daejeon (KR)

(21) Appl. No.: 18/736,768

(22) Filed: Jun. 7, 2024

(30) Foreign Application Priority Data
Oct. 5, 2023 (KR) 10-2023-0132686

(51) Int. Cl. G10L 15/22; G10L 25/30

(52) U.S. Cl. CPC G10L 15/22; G10L 25/30; G10L 2015/225

(57) ABSTRACT

An electronic device according to an embodiment in this document includes a memory configured to store an artificial neural network model and a processor functionally connected to the memory, wherein the processor obtains a user's current utterance, generates a plurality of response candidates according to the current utterance using the artificial neural network model, and performs reinforcement learning on the artificial neural network model by selecting a response according to the current utterance that best matches a specified criterion including a performance indicator from among the plurality of response candidates, using a large pre-trained model.

### CROSS-REFERENCE TO RELATED APPLICATION

This application claims priority to and the benefit of Korean Patent Application No. 10-2023-0132686, filed on Oct. 5, 2023, the disclosure of which is incorporated herein by reference in its entirety.

### BACKGROUND

### 1. Field of the Invention

Various embodiments disclosed in this document relate to reinforcement learning technology based on a large pre-trained model.

### 2. Description of Related Art

Large pre-training models such as OpenAI's Generative Pre-trained Transformer (ChatGPT) and Google's Bidirectional Encoder Representations from Transformers (BERT) may enable pre-training and fine-tuning in natural language processing to provide stable performance for various domains.

Such a large pre-trained model requires large-scale training data for its stability and is being implemented in a universally applicable form by major information technology companies such as Google, Microsoft, and OpenAI, due to the preparation of training data built through manual labeling tasks.

### SUMMARY OF THE INVENTION

Accordingly, general purpose pre-trained models have performance limitations when applied to service domains requiring specific knowledge (e.g., medical care, shopping). There is demand for artificial neural network models for specific fields in small businesses, but it has not yet been met due to cost limitations. There is a need for learning techniques for artificial neural networks that can achieve maximum performance based on a small amount of training data.

Various embodiments disclosed in this document can provide an electronic device capable of performing reinforcement learning on an artificial neural network model based on a large pre-trained model and a reinforcement learning method thereof.

According to an aspect of the present disclosure, an electronic device includes a memory storing an artificial neural network model and a processor functionally connected to the memory, wherein the processor obtains a user's current utterance, generates a plurality of response candidates according to the current speech using the artificial neural network model, and performs reinforcement learning on the artificial neural network model by selecting a response according to the current utterance that best matches a specified criterion including a performance indicator from among the plurality of response candidates, using a large pre-trained model.

According to another aspect of the present disclosure, a reinforcement learning method using at least one processor is provided. The method includes generating a plurality of response candidates related to a response according to a user's current utterance using an artificial neural network model; selecting a response according to the current utterance that best matches a specified performance indicator from among the plurality of response candidates using a large pre-trained model; and performing reinforcement learning on the artificial neural network model based on a reward score according to the performance indicator of the selected response.

According to still another aspect of the present disclosure, an electronic device includes a memory storing at least one instruction and an artificial neural network model; and a processor functionally connected to the memory, wherein when the at least one instruction is executed by the processor, the processor configured to obtains a user's current utterance during execution of, generates a plurality of response candidates according to the current utterance using the artificial neural network model, and performs reinforcement learning on the artificial neural network model by selecting a response according to the current utterance that best matches a specified criterion including a performance indicator from among the plurality of response candidates, using a large pre-trained model.

According to various embodiments disclosed in this document, it is possible to perform reinforcement learning on an artificial neural network model based on a large pre-trained model. In addition, various effects that can be directly or indirectly identified through this document may be provided.

### BRIEF DESCRIPTION OF THE DRAWINGS

FIG. 1 illustrates an implementation environment of an electronic device related to reinforcement learning according to an embodiment.

FIG. 2 is a block diagram illustrating an electronic device according to an embodiment.

FIG. 3 is a diagram illustrating an artificial neural network model and a large pre-trained model according to an embodiment.

FIG. 4 is a diagram illustrating the ranking of response candidates by a large pre-trained model according to an embodiment.

FIG. 5 is a diagram illustrating a method of calculating a first reward score according to a performance indicator according to an embodiment.

FIGS. 6 and 7 are diagrams illustrating a method of calculating a second reward score for a selection response according to system initiative according to an embodiment.

FIGS. 8 and 9 are diagrams illustrating a method of calculating a second reward score for the remaining response candidates according to system initiative according to an embodiment.

FIG. 10 is a flowchart illustrating an artificial neural network model reinforcement learning method according to an embodiment.

In relation to the description of the drawings, the same or similar reference numerals may be used for the same or similar components.

### DETAILED DESCRIPTION OF EXEMPLARY EMBODIMENTS

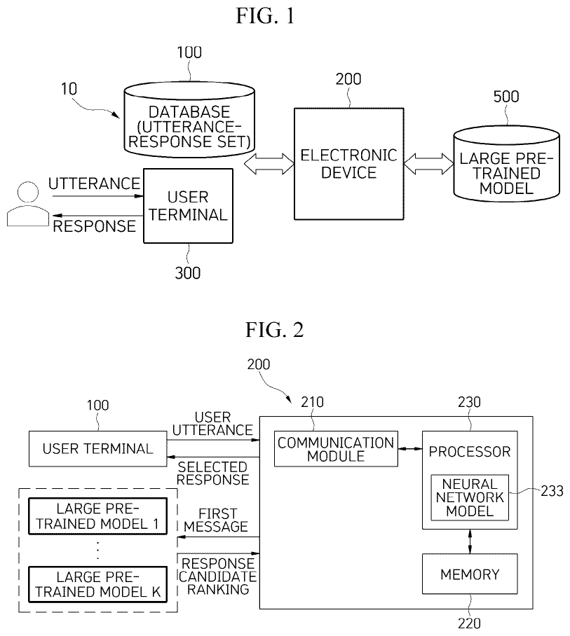

FIG. 1 illustrates an implementation environment of an electronic device related to reinforcement learning according to an embodiment.

Referring to FIG. 1, an electronic device 200 according to the embodiment may acquire a training dataset from a user terminal 300 or a database 100. And an electronic device 200 perform reinforcement learning on an artificial neural network model 233 that executes a first service based on the training dataset.

According to an embodiment, the database 100 is a memory and may include a training dataset for reinforcement learning. The training dataset may include, for example, a user's utterance-response set obtained from conversations between a plurality of users related to a first service. The database 100 may be included in the electronic device 200.

According to an embodiment, the user terminal 300 is a computing device used by a user and may be a device in which a first app for the first service is installed. For example, the user terminal 300 may include at least one of a wearable device, a portable terminal, a smartphone, a smart pad, a laptop computer, and a personal computer.

In a state in which the first app is executed, the user terminal 300 may acquire a user's utterance related to the first service through the first app and transmit the acquired utterance to the electronic device 200 through a specified communication channel. In this regard, the user terminal 300 may acquire the user's utterance through at least one input device selected from a microphone, a touch detection circuit, a keyboard, or a mouse. The user's utterance may include voice input or text input.

The user terminal 300 may acquire a response from the electronic device 200 through the specified communication channel and provide the acquired response to the user in the form of at least one of visual information, auditory information, and tactile information.

According to an embodiment, the electronic device 200 may be a server-type computing device managed by the provider of the first service. The electronic device 200 may be configured to perform reinforcement learning on the artificial neural network model 233 related to the first service using a large pre-trained model and provide a response corresponding to the user's utterance. For example, the first service may include an interactive service (e.g., chatbot service) that provides the response corresponding to the user's utterance for a specified service domain. For example, the specified service domain may be a specific service field such as medical care, shopping, or law.

According to an embodiment, when the user's current utterance is acquired, the electronic device 200 may generate a plurality of response candidates corresponding to the current utterance using the artificial neural network model 233. And the electronic device 200 may select a response that best matches at least a performance indicator from among the plurality of response candidates using a large pre-trained model. The electronic device 200 may perform reinforcement learning on the artificial neural network model 233 based on a first reward score according to the performance indicator of the selected response.

According to an embodiment, the electronic device 200 may predict the user's next utterance following the selected response, and then confirm the similarity with the predicted next utterance when the user's next actual utterance is acquired. For the plurality of response candidates, the electronic device 200 may calculate a second reward score according to the system initiative of the electronic device 200 based on the confirmed similarity.

According to an embodiment, the electronic device 200 may calculate a final reward score by weighted summing the first reward score and the second reward score. And the electronic device 200 may perform reinforcement learning on the artificial neural network model 233 to maximize the final reward score.

According to an embodiment, the electronic device 200 may provide a response corresponding to the user's utterance through the user terminal 300 while performing reinforcement learning or after completing reinforcement learning.

According to an embodiment of the disclosure, the electronic device 200 may perform reinforcement learning on the artificial neural network model 233 to select the most suitable response for the user's utterance which maximizes the final reward score according to the performance indicator and the system initiative based on the large pre-trained model.

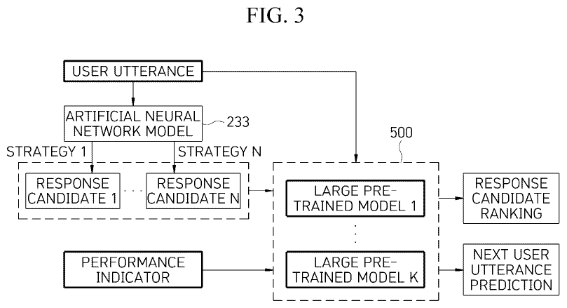

FIG. 2 is a block diagram illustrating an electronic device according to an embodiment, and FIG. 3 is a diagram illustrating a relationship between the artificial neural network model 233 and a large pre-trained model according to an embodiment.

Referring to FIG. 2, the electronic device 200 according to an embodiment may include a communication module 210, a memory 220, and a processor 230. In an embodiment, the electronic device 200 may not include some components or may further include additional components. In addition, some of the components of the electronic device 200 may be combined to constitute a single entity, but the functions of the components before the combination may be performed in the same manner.

The communication module 210 may establish a specified communication channel (communication channel or wireless communication channel) between the electronic device 200 and another device (e.g., the user terminal 300 or the operation server of the large pre-trained model), and support communication through the established communication channel. The communication channel may include, for example, at least one communication channel of a Local Area Network (LAN), a Fiber to the home (FTTH), an X Digital Subscriber Line (xDSL), Wi-Fi, a Wireless Broadband Internet (WiBro), 3G, 4G, or 5G. The communication module 210 may communicate with other devices through a base station by adopting known communication methods such as Code Division Multiple Access (CDMA), a Global System for Mobile communications (GSM), Wideband-CDMA (W-CDMA), Time Division-synchronous CDMA (TD-SCDMA), WiBro, Long-term Evolution (LTE), and an Electronic Product Code (EPC). Alternatively, the communication module 210 may communicate with other devices within a predetermined distance by adopting communication methods such as wireless LAN, Wi-Fi, Bluetooth, ZigBee, Wi-Fi Direct (WFD), Ultrawideband (UWB), Infrared Data Association (IrDA), Bluetooth Low Energy (BLE), near field communication (NFC), etc.

The memory 220 may store a variety of data used by at least one component (e.g., the processor 230) of the electronic device 200. The data may include, for example, input data or output data for software and commands related thereto. For example, the memory 220 may store at least one instruction for performing reinforcement learning on the artificial neural network model 233 based on a large pre-trained model. The memory 220 may store at least one instruction related to the configuration of the artificial neural network model 233, for example, an instruction related to generating a first message based on a user input, an instruction related to calculating a first reward score of response candidates obtained from a large pre-trained model based on the first message, and an instruction related to calculating a second reward score related to system initiative of the response candidates. The memory 220 may store performance indicators. The performance indicators may include, for example, at least one of a quantitative indicator (e.g., prediction probability) and a non-quantitative (qualitative) indicator (e.g., harmfulness, usefulness). The performance indicators can be set by the user.

The memory 220 may include various types of volatile memory or non-volatile memory. For example, the memory may include a read only memory (ROM) and a random access memory (RAM). In an embodiment of the present disclosure, the memory may be located inside or outside a processor, and the memory 220 may be connected to the processor 230 through various known means.

The processor 230 may control at least one other component (e.g., a hardware or software component) of the electronic device 200 by executing at least one instruction, and perform various data processing or calculations. The processor 230 may include at least one of, for example, a central processing unit (CPU), a graphics processing unit (GPU), a microprocessor, an application processor, an application specific integrated circuit (ASIC), and a field programmable gate array (FPGA), and may have a plurality of cores.

The processor 230 may include an artificial neural network model 233 and a similarity evaluation module 235. Alternatively, the artificial neural network model 233 and the similarity evaluation module 235 may include a software module executable by the processor 230. The artificial neural network model 233 may be configured, for example, by training a small amount of training data (e.g., a utterance-response set stored in the database 100) related to a specific service domain. The similarity evaluation module 235 may be configured, for example, by training the similarity of the user's utterance-response dataset and sentences obtained by paraphrasing the utterance-response dataset into various expressions.

According to an embodiment, the processor 230 may acquire the user's utterance from the database 100 or the user terminal 300 through the communication module 210. Alternatively, the processor 230 may acquire the user's utterance through an input module (not shown). However, for convenience of description, a case in which the electronic device 200 acquires real-time user utterance from the user terminal 300 will be described as an example, but the present disclosure is not limited to this.

According to an embodiment, when the user's current utterance is acquired, the processor 230 may generate a plurality of response candidates according to the current utterance using the artificial neural network model 233. Referring to FIG. 3, for example, the processor 230 may generate N response candidates related to a response according to the current utterance based on N response strategies. The N response strategies may be set for response diversity of the artificial neural network model 233, and include at least one strategy implemented according to at least one technique of a model ensemble technique, a dropout technique, top-K or a nucleus sampling technique.

According to an embodiment, the processor 230 may perform reinforcement learning on the artificial neural network model 233 by selecting the response corresponding to the current utterance that best matches a specified criterion (e.g., performance indicator) from among the plurality of response candidates using a large pre-trained model.

According to an embodiment, the processor 230 may provide the response selected from among the plurality of response candidates to the user through the user terminal 300 using the communication module 210. When directly interfacing with the user, the processor 230 may provide the selected response to the user through an output module (not shown).

Hereinafter, reinforcement learning of the artificial neural network model 233 by the processor 230 will be described.

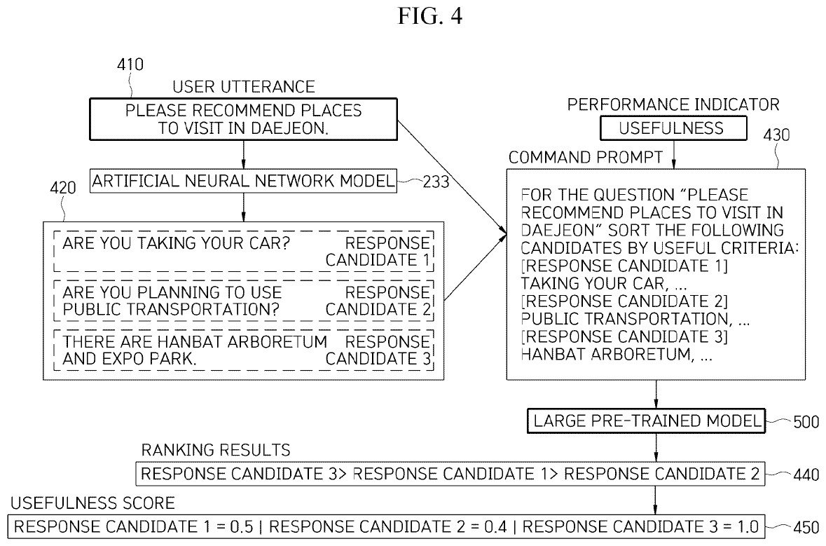

According to an embodiment, the processor 230 may generate a first message related to response selection according to the current utterance and performance indicator from among a plurality of response candidates. For example, the processor 230 may generate a command prompt based on a template. The first message may include a command prompt such as “Arrange the plurality of response candidates according to the current utterance according to the performance indicator.” The generation of the first message by the processor 230 will be described later with reference to FIG. 4.

According to an embodiment, the processor 230 may select a response corresponding to the current utterance based on a result of processing the first message by a large pre-trained model. For example, the processor 230 may input the first message into the large pre-trained model, and acquire the ranking of the plurality of response candidates according to the performance indicator from the large pre-trained model in response to the input of the first message. As another example, the processor 230 may transmit the first message to at least one external server 500 related to the large pre-trained model through the communication module 210, and acquire the ranking of the plurality of response candidates, which are response data corresponding to the first message generated through the large pre-trained model.

According to an embodiment, the processor 230 may calculate a first reward score according to the performance indicator of at least the selected response among the plurality of response candidates, and perform reinforcement learning on the artificial neural network model 233 to optimize at least the first reward score.

According to an embodiment, the processor 230 may acquire the ranking of the plurality of response candidates according to the performance indicator, and calculate the first reward score for the plurality of response candidates by converting the acquired ranking into scores based on a specified equation. For example, the specified equation may be an equation based on the Elo rating method set to score the relative skills of individual players in a one-on-one game. The total of the first reward scores of the response candidates may be 1.

The performance indicator may include a plurality of performance indicators, or the rankings of the plurality of response candidates may be multiple based on a plurality of large pre-trained models. In this case, the processor 230 may calculate the final ranking of the response candidates by averaging the rankings of each of the response candidates, and calculate the first reward score according to each of the response candidates by scoring the final ranking using the specified equation.

According to an embodiment, the processor 230 may use the large pre-trained model to confirm the system initiative of at least the selected response among the plurality of response candidates. And the processor 230 may perform reinforcement learning on the artificial neural network model 233 based on the performance indicator and system initiative.

In relation to the system initiative, the processor 230 may confirm the similarity between the predicted next utterance and the plurality of response candidates. The processor 230 may calculate a second reward score according to the system initiative of the plurality of response candidates based on the confirmed similarity.

For example, the processor 230 may predict the user's next utterance using the large pre-trained model. In this regard, the processor 230 may generate a second message requesting prediction of the next utterance following the current utterance and the selected response. And the processor 230 may input (or transmit) the second message to the large-pre-trained model (or external server 500 related to the large pre-trained model) through the communication module 210. The processor 230 may acquire the predicted next utterance in response to the second message.

When the user's next actual utterance is acquired, the processor 230 may calculate the similarity between the conversation history to date, the selected response candidate, the predicted next utterance and the actual utterance. The processor 230 may determine the calculated similarity as a second reward score according to the system initiative of the selected response.

In addition, the processor 230 may calculate the similarity between the plurality of response candidates. and calculate second reward scores according to the system initiative of the plurality of response candidates by combining (e.g., multiplying) the second reward score of the selected response and the calculated similarity between the plurality of response candidates.

According to an embodiment, the processor 230 may calculate a final reward score by weighted summing the first reward scores according to the performance indicator calculated for each of the plurality of response candidates and the second reward scores according to the system initiative. The processor 230 may perform reinforcement learning on the artificial neural network model 233 to maximize the final reward score.

According to an embodiment, the processor 230 may update the parameter of the artificial neural network model 233 based on at least one learning method of a policy gradient method or a Q-learning method. The processor 230 may configure the artificial neural network model 233 to maximize the final reward score while updating the parameter of the artificial neural network model 233. By repeating the above-described process, the artificial neural network model 233 may be gradually modeled to be suitable for an interactive service of a specific service domain.

According to an embodiment, the electronic device 200 may develop the interactive artificial neural network model 233 interacting with the user to respond to specific fields by performing learning on the artificial neural network model 233 according to a specified performance indicator using a large pre-trained model, even if only a small amount of training data exists.

In addition, according to an embodiment, the electronic device 200 may confirm the system initiative of an interactive system, and perform learning on the artificial neural network model 233 according to the system initiative as well as the performance indicator to configure the artificial neural network model 233, thereby providing the maximum performance even with a small amount of data.

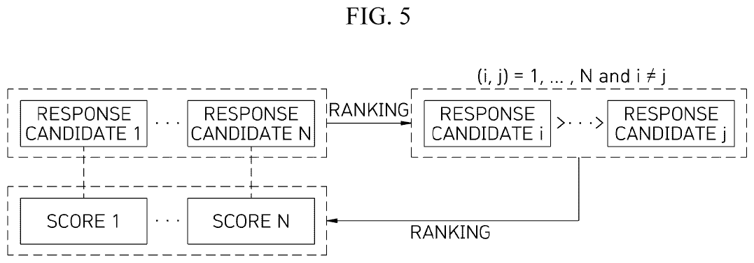

FIG. 4 is a diagram illustrating the ranking of response candidates by a large pre-trained model according to an embodiment, and FIG. 5 is a diagram illustrating a method of calculating a first reward score according to the ranking of response candidates (a performance indicator) according to an embodiment.

Referring to FIG. 4, in operation 410, when the electronic device 200 acquires user utterance “Please recommend places to visit in Daejeon,” in operation 420, the electronic device 200 may input the user utterance into the artificial neural network model 233 to acquire response candidates 1 to 3.

In operation 430, the electronic device 200 may generate a command prompt including user utterance, response candidates, and ranking criteria (performance indicator: usefulness). For example, the command prompt (first message) may be “Please sort response candidates 1 to 3 based on the performance indicator ‘usefulness’ according to a user input (utterance).” The electronic device 200 may input the generated command prompt into the large pre-trained model. In an embodiment, the electronic device 200 may generate the command prompt based on a template.

In operation 440, the large pre-trained model may sort the response candidates 1 to 3 sorted (ranked) according to the usefulness criteria.

In operation 450, the electronic device 200 may convert the rankings of the response candidates 1 to 3 into a usefulness score (first reward score) using a specified equation related to the Elo rating. Referring to FIGS. 3 and 5, the ranking of the response candidates 1 to 3 determined by the electronic device 200 may be different from the ranking calculated by the large pre-trained model. In this case, the electronic device 200 may calculate a reward (first reward score) according to the performance indicator for the response candidate using only the ranking calculated through the large pre-trained model.

Meanwhile, referring to FIG. 3, according to an embodiment, the electronic device 200 may use K large pre-trained models or use multiple performance indicators for one large pre-trained model. In this case, the electronic device 200 may acquire a plurality of ranking results regarding the response candidates from at least one large pre-trained model. Next, the electronic device 200 may calculate the final ranking by combining (e.g., averaging) all ranking results for the plurality of response candidates. The electronic device 200 may convert the final ranking calculated by combining (e.g., averaging) a plurality of ranking results into a first reward score through a specified equation. The electronic device 200 may perform reinforcement learning on the artificial neural network model 233 to minimize at least the first reward score.

In this manner, the electronic device 200 according to an embodiment may rank the response candidates generated through the artificial neural network model 233 according to the performance indicator using the large pre-trained model, and determine a reward (first reward score) for the artificial neural network model 233 based on the results ranked by the large pre-trained model.

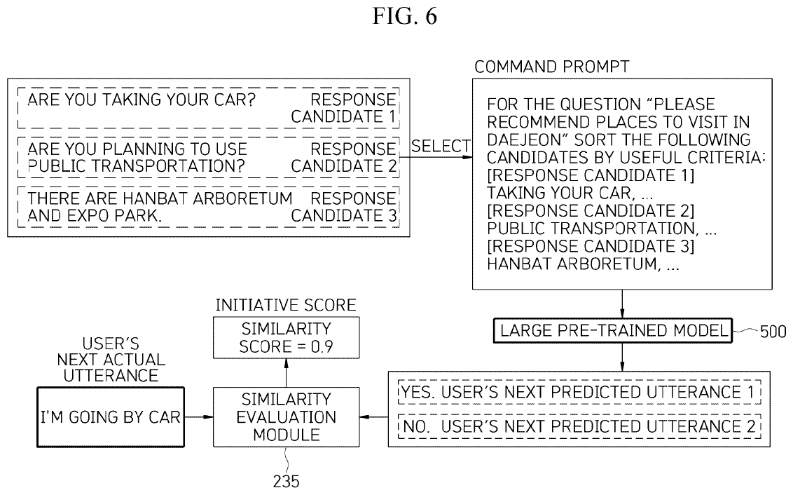

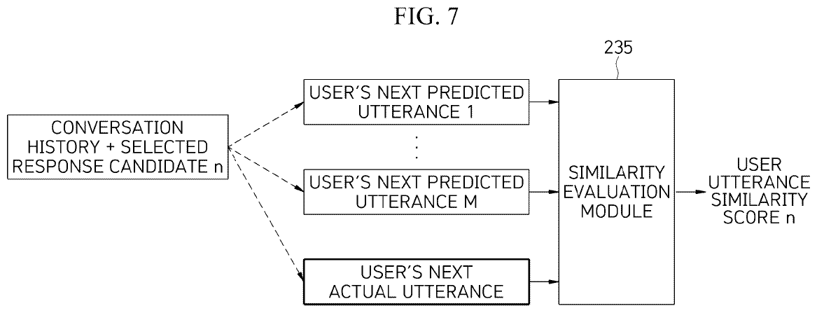

FIGS. 6 and 7 are diagrams illustrating a method of calculating a second reward score for a selection response in accordance with system initiative according to an embodiment.

According to an embodiment, the electronic device 200 may confirm the accuracy or similarity (prediction probability) of the artificial neural network model 233 by predicting the user's next utterance that will follow the current conversation context and comparing the predicted next utterance with the user's next actual utterance. The electronic device 200 may calculate the confirmed accuracy or similarity (a prediction probability) as a second reward score for the selected response. In addition, the higher the probability of predicting the next user utterance, the better the electronic device 200 determines the conversation flow. Therefore, the probability of predicting the next utterance may be confirmed as the system's initiative score of the electronic device 200.

Referring to FIG. 6, the electronic device 200 may generate a second message (command prompt) for requesting prediction of the user's current utterance and the user's next utterance following the selected user utterance from among the plurality of response candidates 1 to 3 for the current utterance. The electronic device 200 may input the second message into the large pre-trained model, and receive at least one next utterance candidate from the large pre-learned model in response to the second message.

Referring to FIGS. 6 and 7, the similarity evaluation module 235 may calculate the similarity score of the selected response by comparing the conversation history to date, the selected response candidate, and M predicted user utterance candidates with the user's next actual utterance. The electronic device 200 may determine the similarity score of the selected response as the second reward score related to the system initiative of the electronic device 200.

In this manner, the electronic device 200 according to an embodiment may calculate the second reward score (initiative score) for the system initiative based on the prediction of the user's next utterance as well as the first reward score for the performance indicator, and use the second reward score for reinforcement learning.

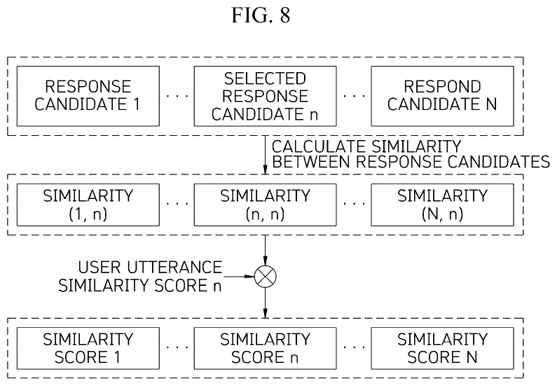

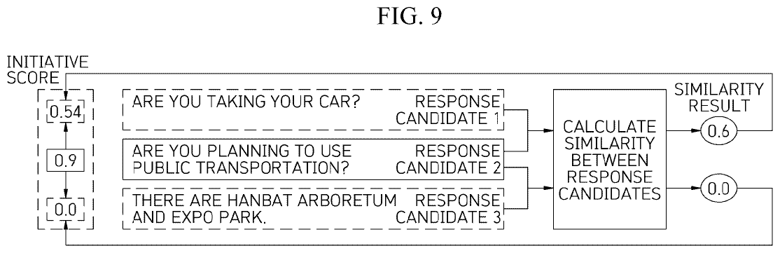

FIGS. 8 and 9 are diagrams illustrating a method of calculating a second reward score for the remaining response candidates in accordance with system initiative according to an embodiment.

According to an embodiment, the electronic device 200 may calculate a second reward score related to the system initiative of the remaining unselected response candidates based on the second reward score related to the system initiative of the selected response.

Referring to FIGS. 8 and 9, the electronic device 200 may calculate the similarity between a plurality of response candidates, and multiply the second reward score according to the system initiative of the selected response by the similarity between the remaining response candidates, thereby respectively obtaining the multiplied second reward score as the second reward score of the remaining response candidates.

In this manner, the electronic device 200 according to an embodiment may calculate the initiative score for the remaining response candidates based on the second reward score in accordance with the system initiative of the selected response candidate, and perform reinforcement learning on the artificial neural network model 233 based on the second reward scores.

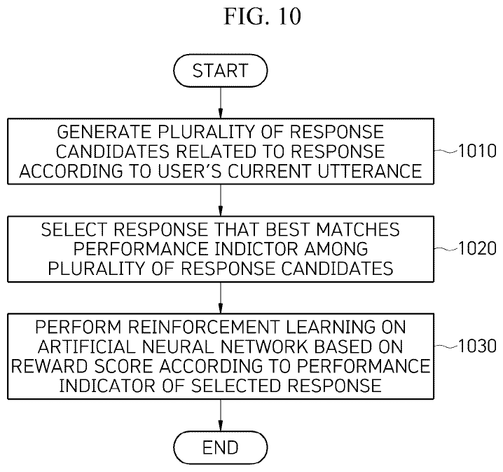

FIG. 10 is a flowchart illustrating an artificial neural network model reinforcement learning method according to an embodiment.

Referring to FIG. 10, in operation 1010, when the user's current utterance is acquired, the electronic device 200 may generate a plurality of response candidates corresponding to the current utterance using the artificial neural network model 233.

In operation 1020, the electronic device 200 may select a response according to the current utterance that best matches a specified performance indicator from among the plurality of response candidates using a large pre-trained model. For example, the electronic device 200 may generate a first message related to the current utterance and response selection according to the performance indicator among the plurality of response candidates. And the electronic device 200 may select a response according to the current utterance based on a result of processing the first message by the large pre-trained model.

In operation 1030, the electronic device 200 may perform reinforcement learning on the artificial neural network model 233 according to a reward score according to the performance indicator of the selected response candidate. For example, the electronic device 200 may determine a reward score based on at least one criterion including the performance indicator for the plurality of response candidates using a large pre-trained model. The electronic device 200 may perform reinforcement learning on the artificial neural network model 233 so that the reward score according to the at least one criterion increases. As another example, the electronic device 200 may predict the user's next utterance based on the conversation history to date and the selected response. The electronic device 200 may determine an initiative reward score of the selected response based on the similarity between the user's next actual utterance and the predicted utterance. The electronic device 200 may calculate the similarity between the plurality of response candidates, and calculate the initiative reward score of the remaining response candidates other than the selected response among the plurality of response candidates based on a product of the calculated similarity and the initiative reward score of the selected response. In an embodiment, the electronic device 200 may calculate a weighted sum of the initiative reward score and reward score according to the performance indicator as a final reward score, and adjust the parameter of the artificial neural network model 233 to maximize the final reward score.

As described above, the electronic device 200 according to an embodiment may utilize one or more large pre-trained models to perform reinforcement learning on the artificial neural network model 233 to increase the performance indicator and system initiative.

In addition, the electronic device 200 according to an embodiment may use a general-purpose large pre-trained model to perform reinforcement learning on the artificial neural network model 233 that provides an interactive service of a specific service domain constructed based on a small amount of training data.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, phrases such as “A or B,” “at least one of A and B,” “at least one of A or B,” “A, B, or C,” “at least one of A, B, and C,” and “at least one of A, B, or C” may each include any one of, or all possible combinations of the items enumerated together in the corresponding phrase. As used herein, such terms as “₁I” and “_{2nd},” or “first” and “second” may be used to simply distinguish a corresponding component from another, and do not limit the components in other aspects (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., wirely), wirelessly, or via a third element.

As used herein, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in the form of an application-specific integrated circuit (ASIC).

Various embodiments as set forth herein may be implemented as software (e.g., a program) including one or more instructions that are stored in a storage medium (e.g., the memory 220 of FIG. 2) (e.g., an internal memory or external memory) that is readable by a machine (e.g., an electronic device). For example, a processor (e.g., the processor 230) of the machine (e.g., the electronic device 200) may invoke at least one of the one or more instructions stored in the storage medium, and execute it, with or without using one or more other components under the control of the processor. This allows the machine to be operated to perform at least one function according to the at least one invoked instruction. The one or more instructions may include a code generated by a compiler or a code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium or where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., a compact disc read only memory (CD-ROM)), or distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as a memory of the manufacturer's server, a server of the application store, or a relay server.

The components according to the embodiment of the present disclosure may be implemented in the form of software or hardware such as a DSP, FPGA, or ASIC, and perform predetermined roles. The “components” are not limited to software or hardware, and each component may be configured to be in an addressable storage medium or to reproduce one or more processors. For example, the components include components such as software components, object-oriented software components, class components, and task components, processors, functions, attributes, procedures, subroutines, segments of a program code, drivers, firmware, a microcode, a circuit, data, a database, data structures, tables, arrays, and variables.

According to various embodiments, each component (e.g., module or program) of the above-described components may include a single entity or a plurality of entities, and some of the plurality of entities may be separately disposed in other components. According to various embodiments, one or more components or operations among the aforementioned corresponding components may be omitted, or one or more other components or operations may be added. Alternatively or additionally, a plurality of components (e.g., modules or programs) may be integrated into a single component. In this case, the integrated component may perform one or more functions of each of the plurality of components identically or similarly to those performed by a corresponding component of the plurality of components prior to the integration. According to various embodiments, the operations performed by a module, program, or other component are executed sequentially, in parallel, iteratively, or heuristically, or one or more of the operations are executed in a different order, or omitted, or one or more other actions may be added.

What is claimed is:

1. An electronic device comprising:
a memory configured to store an artificial neural network model; and
a processor functionally connected to the memory,
wherein the processor is configured to:
obtain a user's current utterance and generate a plurality of response candidates according to the current utterance using the artificial neural network model; and
perform reinforcement learning on the artificial neural network model by selecting a response according to the current utterance that best matches a specified criterion including a performance indicator from among the plurality of response candidates, using a large pre-trained model.

2. The electronic device of claim 1, wherein the processor is configured to:
generate a first message related to response selection according to the current utterance and the performance indicator, and input the first message into the large pre-trained model; and
select a response according to the current utterance based on a result of processing the first message by the large pre-trained model.

3. The electronic device of claim 2, further comprising a communication module,
wherein the processor transmits the first message to an external server related to the large pre-trained model, and the external server acquires the processing result based on the large pre-trained model through the communication module.

4. The electronic device of claim 1, wherein the processor is configured to:
receive rankings of the plurality of response candidates according to the performance indicator from the large pre-trained model;
calculate a first reward score by scoring the rankings of the plurality of response candidates based on a specified equation; and
perform reinforcement learning on the artificial neural network model based on at least the first reward score.

5. The electronic device of claim 4, wherein, when the performance indicator includes a plurality of indicators or the large pre-trained model includes a plurality of large pre-trained models, the processor calculates a final ranking by averaging rankings respectively determined based on the plurality of indicators or the plurality of large pre-trained models.

6. The electronic device of claim 4, wherein the specified equation is an equation based on an Elo rating method.

7. The electronic device of claim 4, wherein the processor is configured to:
predict next utterance of the user based on the current utterance and the selected response using the large pre-trained model; and
determine a second reward score of the selected response based on similarity between next actual utterance of the user and the predicted next utterance.

8. The electronic device of claim 7, wherein the processor calculates a second reward score for the remaining responses other than the selected response among the plurality of response candidates based on similarity between the remaining responses and the selected response.

9. The electronic device of claim 8, wherein the processor calculates a final reward score of each of the response candidates by weighted summing the first reward scores and the second reward scores and performs reinforcement learning on the artificial neural network model to maximize final reward score.

10. The electronic device of claim 8, wherein the processor updates a parameter of the artificial neural network model to maximize a final reward score based on a policy gradient method.

11. The electronic device of claim 1, wherein the performance indicator includes at least one of a quantitative indicator and a qualitative indicator of at least one of harmfulness and usefulness.

12. A reinforcement learning method, which is performed by at least one processor, comprising:
generating a plurality of response candidates related to a response according to a user's current utterance using an artificial neural network model;
selecting a response according to the current utterance that best matches a specified performance indicator from among the plurality of response candidates using a large pre-trained model; and
performing reinforcement learning on the artificial neural network model based on a reward score according to the performance indicator of the selected response.

13. The reinforcement learning method of claim 12, wherein the selecting of the response includes:
generating a first message related to, among the plurality of response candidates, response selection according to the current utterance and the performance indicator; and
selecting a response according to the current utterance based on a result of processing the first message by the large pre-trained model.

14. The reinforcement learning method of claim 12, wherein the performing of the reinforcement learning includes:
determining a reward score according to at least one criterion including the performance indicator for the plurality of response candidates using the large pre-trained model; and
performing reinforcement learning on the artificial neural network model to increase the reward score according to the at least one criterion.

15. The reinforcement learning method of claim 14, wherein the determining of the reward score includes:
predicting next utterance of the user based on a conversation history including the current utterance and the selected response; and
determining the reward score of the selected response based on similarity between next actual utterance of the user and the predicted next utterance.

16. The reinforcement learning method of claim 14, wherein the determining of the reward score includes calculating a reward score of remaining response candidates other than the selected response among the plurality of response candidates based on similarity between the remaining response candidates and the selected response.

17. The reinforcement learning method of claim 12, wherein the determining of the reward score includes:
determining rankings of the plurality of response candidates using the large pre-trained model; and
converting the determined rankings into reward scores based on the specified equation.

18. The reinforcement learning method of claim 12, wherein the performing of the reinforcement learning includes:
calculating each of the reward scores of the plurality of response candidates;
calculating a final reward score by weighted summing the calculated reward scores; and
performing reinforcement learning on the artificial neural network model to maximize the final reward score.

19. The reinforcement learning method of claim 18, wherein the performing of the reinforcement learning to maximize the final reward score includes updating a parameter of the artificial neural network model to maximize the final reward score based on a policy gradient method.

20. An electronic device comprising:
a memory configured to store at least one instruction and an artificial neural network model; and
a processor functionally connected to the memory,
wherein, when the at least one instruction is executed, the processor is configured to:
obtain a user's current utterance and generate a plurality of response candidates according to the current utterance using the artificial neural network model; and
perform reinforcement learning on the artificial neural network model by selecting a response according to the current utterance that best matches a specified criterion including a performance indicator from among the plurality of response candidates, using a large pre-trained model.
